(19) United States
(12) Patent Application Publication
(10) Pub. No.: US 2006/0158497 A1
(43) Pub. Date: Jul. 20, 2006

(54) Ink-jet printing of compositionally non-uniform features

(76) Inventors: Karel Vanheusden, Placitas, NM (US); James John Howarth, Albuquerque, NM (US); Chuck Edwards, Rio Rancho, NM (US)

Correspondence Address: Jaimes Sher, Esq.;Cabot Corporation, 5401 Venice Avenue NE, Albuquerque, NM, 87113, US

(21) Appl. No.: 11/331,237

(22) Filed: Jan. 13, 2006

Related U.S. Application Data
(60) Provisional application No. 60/695,421, filed on Jul. 1, 2005.
(60) Provisional application No. 60/643,629, filed on Jan. 14, 2005.
(60) Provisional application No. 60/643,577, filed on Jan. 14, 2005.
(60) Provisional application No. 60/643,578, filed on Jan. 14, 2005.

(51) Int. Cl. G01D 11/00

(52) U.S. Cl. 347/100

(57) ABSTRACT

A process for fabricating an electrical component having at least one anisotropic electrical quality is provided. The process includes the step of ink-jet printing a plurality of dots of each of at least two electronic inks in a predetermined pattern such that the anisotropic electrical quality is manifested. The ink-jet printing step may further include the steps of: selecting a first electronic ink having a known first electrical characteristic; selecting a second electronic ink having a known second electrical characteristic; determining a positional layout for each of a plurality of dots for each of the first and second electronic inks such that the determined positional layout provides a response of the electrical component in accordance with the anisotropic electrical quality; and printing each of the plurality of dots of each of the first and second electronic inks onto a substrate according to the determined positional layout.

### CROSS-REFERENCE TO RELATED APPLICATIONS

This application claims priority to U.S. Provisional Patent Application Ser. Nos. 60/643,577; 60/643,378; and 60/643,629, all filed on Jan. 14, 2005, the entireties of which are incorporated herein by reference. This application also claims priority to U.S. Provisional Patent Application Ser. No. 60/695,421, filed on Jul. 1, 2005, the entirety of which is incorporated herein by reference.

### BACKGROUND OF THE INVENTION

1. Field of the Invention

The present invention relates to ink-jet printing of electrical components. More particularly, the invention relates to a method and apparatus for printing electrical components onto a substrate using electronic inks that takes operational and environmental parameters into account in determining a positional layout of the electronic inks.

2. Related Art

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Ink-jet printing of conductors has been explored, but the approaches to date have been inadequate for producing well-defined features with good electrical properties, particularly at relatively low temperatures.

There exists a need for compositions for the fabrication of electrical conductors for use in electronics, displays, and other applications. Further, there is a need for compositions that have low processing temperatures to allow deposition onto organic substrates and subsequent thermal treatment. It would also be advantageous if the compositions could be deposited with a fine feature size, such as not greater than about 100 μm, while still providing electronic features with adequate electrical and mechanical properties.

An advantageous metallic ink and its associated deposition technique for the fabrication of electrically electrical conductors would combine a number of attributes. The electrical conductor would have high conductivity, preferably close to that of the pure bulk metal. The processing temperature would be low enough to allow formation of conductors on a variety of organic substrates (polymers). The deposition technique would allow deposition onto surfaces that are non-planar (e.g., not flat). The conductor would also have good adhesion to the substrate. The composition would desirably be ink-jet printable, allowing the introduction of cost-effective material deposition for production of devices such as flat panel displays (PDP, AMLCD, OLED). The composition would desirably also be flexo, gravure, or offset printable, again enabling lower cost and higher yield production processes as compared to screen printing.

Further, there is a need for electronic circuit elements, particularly electrical conductors, and complete electronic circuits fabricated on inexpensive, thin and/or flexible substrates, such as paper, using high volume printing techniques such as reel-to-reel printing. Recent developments in organic thin film transistor (TFT) technology and organic light emitting device (OLED) technology have accelerated the need for complimentary circuit elements that can be written directly onto low cost substrates. Such elements include conductive interconnects, electrodes, conductive contacts and via fills. In addition, there is a need to account for operational and environmental conditions in the manufacture of such circuit elements.

Existing printed circuit board technologies use process steps and rigidly define the printed circuit board in the context of layers. Only one layer of conductive material is permitted per layer due to the copper etch process used. In general, devices cannot be mounted on internal layers.

### SUMMARY OF THE INVENTION

In one aspect, the invention provides a process for fabricating an electrical component having at least one anisotropic electrical quality. The process includes the step of ink-jet printing a plurality of droplets of each of at least two electronic inks in a predetermined pattern such that the anisotropic electrical quality is manifested. The ink-jet printing step may further include the steps of: selecting a first electronic ink having a known first electrical characteristic; selecting a second electronic ink having a known second electrical characteristic; determining a positional layout for each of a plurality of droplets for each of the first and second electronic inks such that the determined positional layout provides a response of the electrical component in accordance with the anisotropic electrical quality; and printing each of the plurality of droplets of each of the first and second electronic inks onto a substrate according to the determined positional layout.

The positional layout may be three-dimensional. The step of determining a positional layout may further include providing a unique set of three coordinates to each droplet of each of the first and second electronic inks, wherein a first coordinate and a second coordinate jointly specify a unique position on the substrate and a third coordinate specifies an ink layer. In this instance, when two droplets have matching first and second coordinates, the droplet having a greater third coordinate is positioned directly above the droplet having a lesser third coordinate.

The anisotropic electrical quality may be selected from the group consisting of directional conductivity; graded resistivity; directional inductance; graded inductance; and graded permittivity. The known first and second electrical characteristics may be selected from the group consisting of conductivity, resistivity, permittivity, and dielectric constant. The step of printing may include using an ink-jet printer having at least two ink-jet heads to print each of the plurality of droplets of the first electronic ink using a first ink-jet head and to print each of the plurality of droplets of the second electronic ink using a second ink-jet head.

### BRIEF DESCRIPTION OF THE DRAWINGS

FIGS. 1a, 1b, and 1c illustrate a positional layout of a directional conductor fabricated using an ink-jet printer according to a preferred embodiment of the invention.

FIGS. 2a, 2b, and 2c illustrate a positional layout of a directional dielectric device fabricated using an ink-jet printer according to a preferred embodiment of the invention.

FIGS. 3a, 3b, and 3c illustrate a positional layout of a directional inductor fabricated using an ink-jet printer according to a preferred embodiment of the invention.

FIGS. 4a, 4b, and 4c illustrate a positional layout of a printed resistor fabricated using an ink-jet printer according to a preferred embodiment of the invention.

FIG. 5 illustrates a positional layout of a resistor having a resistivity gradient that is fabricated using an ink-jet printer according to a preferred embodiment of the invention.

FIG. 6 illustrates a positional layout of another exemplary resistor having a resistivity gradient that is fabricated using an ink-jet printer according to a preferred embodiment of the invention.

FIG. 7 illustrates a positional layout of a dielectric device having a dielectric constant gradient that is fabricated using an ink-jet printer according to a preferred embodiment of the invention.

FIG. 8 illustrates a positional layout of an inductor having an inductance gradient that is fabricated using an ink-jet printer according to a preferred embodiment of the invention.

### DETAILED DESCRIPTION OF THE INVENTION

Digital ink-jet printing of electronic materials enables printing of electronic features that have compositions that are non-uniform and/or functionally graded, including compositions with anisotropic electrical properties. In a preferred embodiment of the invention, two or more electronic ink materials are patterned onto a substrate. The resolution or positional accuracy of the placement of the materials should be at most 100 μm. Preferably, this resolution is at most 50 μm, and even more preferably, the resolution is at most 25 μm. Other printing techniques, such as screen printing or flexo-printing, may also be used to accomplish this with a material to material registration accuracy better than 100 μm.

The method of digital printing of electronic ink materials to form electrical elements enables a circuit designer to be extremely precise in producing an element having a desired electrical characteristic. The circuit designer can accomplish this precision by choosing electronic ink materials having specific electrical characteristics when cured, and by controlling both the print layout of the electronic inks used and the thickness of those inks. Such precision enables the circuit designer a high degree of predictability with respect to the electrical characteristics of the printed circuit.

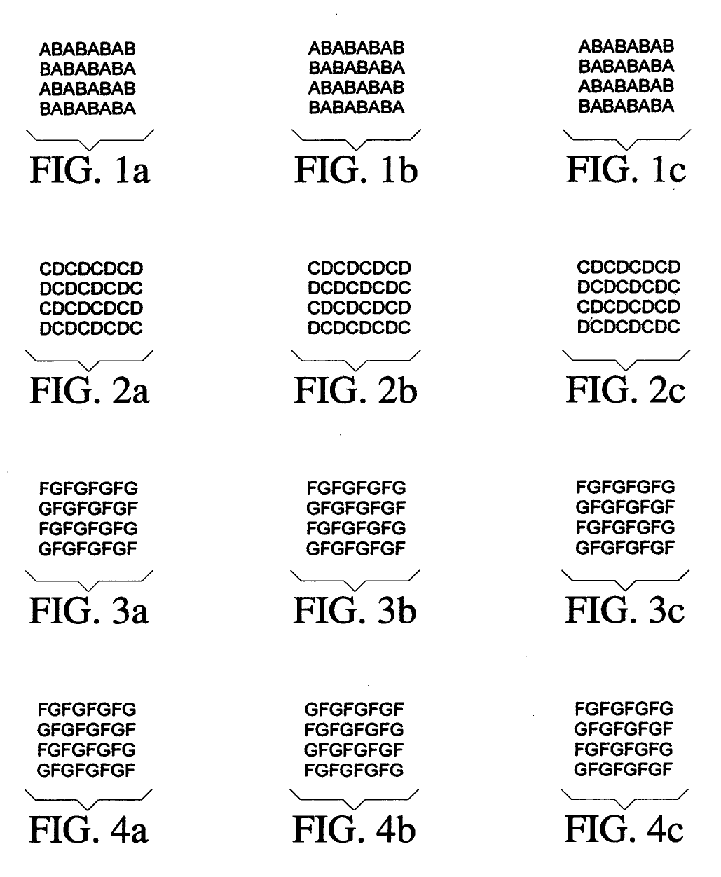

In one embodiment of the present invention, an ink-jet printer is used to deposit at least two different electronic ink materials by using two ink-jet print heads. The two electronic ink materials are carefully chosen on the basis of the electrical characteristics of each ink when cured. For example, referring to FIGS. 1a, 1b, and 1c a dot pattern can be printed using a conductive material such as silver ink, represented by the symbol A, and an insulative material such as polyimide ink, represented by the symbol B. Every symbol represents a single dot of ink-jet printed material printed onto a substrate. A dot may be a single droplet of ink, or a dot may include a group of droplets having a predetermined droplet pattern. FIG. 1a illustrates a first layer of deposited electronic ink; i.e., this first layer is printed directly onto the substrate surface. FIG. 1b illustrates a second layer of deposited electronic ink; i.e., this second layer is printed on top of the first layer, in correspondingly respective positions. FIG. 1c represents a third layer of deposited electronic ink, which is printed on top of the second layer. It is noted that any number of additional layers of electronic ink may be printed, each successively on top of the previous layer.

For descriptive purposes, it is assumed that the substrate surface is coplanar with an X-axis and a Y-axis, and that a Z-axis is orthogonal to the substrate surface. Referring again to the implementation illustrated in FIGS. 1a, 1b, and 1c, a Z-axis conductor is printed with a high electrical conductivity in the Z direction, and a low electrical conductivity in the X and Y directions. In each of the X and Y directions, every dot of conductive silver ink is abutted by a dot of insulative polyimide ink, and every dot of insulative polyimide ink is abutted by a dot of conductive silver ink. Conversely, in the Z direction, after the first layer has been deposited, every dot of conductive silver ink is deposited directly on top of a previously deposited dot of conductive silver ink, and every dot of insulative polyimide ink is deposited directly on top of a previously deposited dot of insulative polyimide ink. In this manner, current will tend to flow in the Z direction, from silver ink dot to silver ink dot, and not in the X or Y directions, where there are no abutting conductive silver ink dots. If desired, the conductive device can be produced such that the direction of conductivity is either the X direction or the Y direction instead of the Z direction, by selecting an appropriate ink dot layout such that the abutting conductive silver ink dots are arranged in the desired direction.

Referring to FIGS. 2a, 2b, and 2c, another exemplary ink dot layout includes a material with high dielectric constant, represented by the symbol C, and a material with a low dielectric constant, represented by the symbol D. A first layer, which is deposited directly onto the substrate surface, is illustrated in FIG. 2a; a second layer, which is deposited on top of the first layer in corresponding positions, is illustrated in FIG. 2b; and a third layer, which is deposited directly on top of the second layer, is illustrated in FIG. 2c. Once again, any number of additional layers having the same ink dot layout may be printed, each successively on top of the previously deposited layer. In this example, an anisotropic electronic device having a high dielectric constant in the Z direction and a low dielectric constant in the X and Y directions is produced. If desired, the dielectric device can be produced such that the direction having a high dielectric constant is either the X direction or the Y direction instead of the Z direction, by selecting an appropriate ink dot layout such that the abutting ink droplets having a high dielectric constant are arranged in the desired direction.

Referring to FIGS. 3a, 3b, and 3c, a third exemplary ink dot layout includes a relatively highly magnetic material, such as nickel, cobalt, iron, or a composition containing one or more of these metals, and a material with relatively low magnetization properties, such as a dielectric material. The highly magnetic ink is represented by the symbol F and the ink having low magnetization is represented by the symbol G. A first layer, which is deposited directly onto the substrate surface, is illustrated in FIG. 3a; a second layer, which is deposited on top of the first layer in corresponding positions, is illustrated in FIG. 3b; and a third layer, which is deposited directly on top of the second layer, is illustrated in FIG. 3c. Once again, any number of additional layers having the same ink dot layout may be printed, each successively on top of the previously deposited layer. In this example, an anisotropic device having a high inductance in the Z direction and a low inductance in the X and Y directions is produced. In addition, such a device exhibits lower magnetic loss than an isotropic material. If desired, the inductive device can be produced such that the direction of high inductance is either the X direction or the Y direction instead of the Z direction, by selecting an appropriate ink dot layout such that the abutting highly magnetic ink dots are arranged in the desired direction.

Referring to FIGS. 4a, 4b, and 4c, a fourth exemplary ink dot layout uses the same inks as shown in FIGS. 3a, 3b, and 3c. A first layer, which is deposited directly onto the substrate surface, is illustrated in FIG. 4a; a second layer, which is deposited on top of the first layer in corresponding positions, is illustrated in FIG. 4b; and a third layer, which is deposited directly on top of the second layer, is illustrated in FIG. 4c. In this example, the second layer has the ink dot positions exactly reversed from each of the first and third layers. Once again, any number of additional layers having the same ink dot layout may be printed, with each successive layer having the exact reverse ink layout as the previously deposited layer. In this example, the resulting device is isotropic, and it exhibits a checkerboard magnetization characteristic.

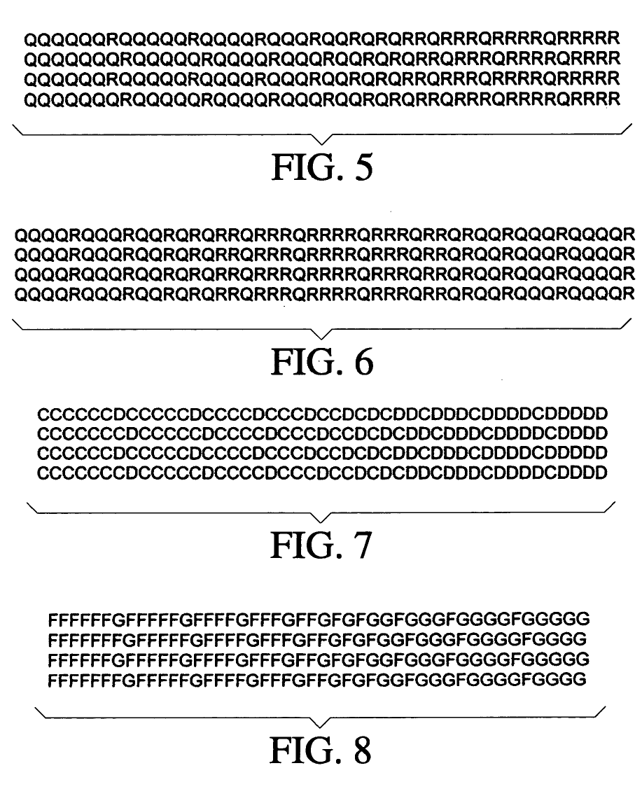

Referring to FIG. 5, in another exemplary embodiment of the present invention, a device having a resistivity gradient includes two electronic inks, represented by Q and R respectively. The first ink Q has a relatively low resistivity value when cured, and the second ink R has a relatively high resistivity value when cured. Therefore, because there are more Q dots toward the left side of the device, and the number of R dots gradually increases from left to right, accordingly the resistivity gradient increases from low to high. This type of device may be useful as a signal line termination application.

Referring to FIG. 6, another exemplary ink dot layout uses the same two inks as shown in FIG. 5. In this example, the resistivity gradient starts at left with a low resistivity, increases to a high resistivity at the center of the device, then decreases back to a low resistivity at the right side of the device. This device may be used as a standard resistor to enhance the tolerance of the printed resistor component when there is poor registration between the resistor material and the resistor electrodes.

Referring to FIG. 7, a device having a graded dielectric constant has a similar ink dot layout as that shown in FIG. 5. The two inks used are a material with high dielectric constant, represented by the symbol C, and a material with a low dielectric constant, represented by the symbol D. The resulting device has a relatively high dielectric constant at the left side, and the dielectric constant gradually decreases from left to right. An application for a graded dielectric device is as a gate dielectric for use in a metal-oxide-semiconductor field effect transistor (MOSFET). The gate is located at the high-K end of the gate dielectric device (i.e., the left side of FIG. 7), and the source and drain of the MOSFET are located at the low-K end of the gate dielectric device (i.e., the right side of FIG. 7).

Referring to FIG. 8, a device having a graded inductance constant has a similar ink dot layout as those shown in FIGS. 5 and 6. The two inks used are a highly magnetic material, represented by the symbol F, and a material having low magnetization, such as a dielectric material, represented by the symbol G. The resulting device has a relatively high inductance at the left side, and the inductance gradually decreases from left to right.

In another aspect of the present invention, variation in the thickness of the selected electronic inks can be used to produce desired electrical characteristics. For example, a conductive element having a tapering thickness can be fabricated for use as an RFID antenna. Such an application is useful, because an RFID antenna may be quite lengthy, but typically, the antenna does not require uniform thickness throughout its entire length. By tapering the thickness, material can be conserved. This may translate into cost savings, for example, if a conductive silver ink is used. Thickness variations may also be used to tailor circuit elements based on characteristics such as a desired voltage rating.

The ink dots can be interlaced in various ways. In some applications, two inks that do not blend are used, such as a water-based ink and an oil-based ink. This creates a matrix of two discrete components. A first ink can be printed first and can be cured, either partially or completely, before the second ink is printed.

Alternatively, blendable inks can be partially blended on the substrate. Blending of inks can be accomplished by printing “wet on wet”, i.e., printing the second ink while the first ink is still wet and has not yet cured. Blending may also be accomplished by printing “wet next to wet”, i.e., printing the second ink in positions that directly abut dots of the first ink within the same layer prior to curing. The quality of such blends is enhanced by selecting inks formulations that can be blended easily. In addition, for applications that use gradients, such as the graded resistor illustrated in FIG. 5 or 6 or the graded dielectric device illustrated in FIG. 7 or the graded inductor illustrated in FIG. 8, inks may be selectively chosen such that the gradient is smoothed out because the electrical characteristics of the chosen inks are relatively close in magnitude. For example, for the graded resistor of FIG. 5, a choice of two inks whose resistivities are unequal but close in magnitude will enable the gradient to be a smooth, gradual gradient. By contrast, for applications in which a sharp, discrete distinction is needed, such as the directional conductor illustrated in FIG. 1, inks having sharply distinct characteristic values may be chosen to accentuate the desired application.

In some applications, three or more electronic ink materials may be used. For example, an anisotropic circuit element may include the use of a conductive silver ink in conjunction with a semiconductive silicon ink. For some applications, a third ink, such as a nickel ink to be used as a barrier layer between the silver ink and the silicon ink, may also be employed. In designing the circuit elements, a user has tremendous leeway in selecting any number and any types of inks that provide the desired characteristics for the printed element.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, although the preferred embodiments of the invention illustrate the ink dot patterns in the drawings as being deposited in the x-y plane, ink may alternatively be deposited so that the same dot patterns are manifested in either the x-z plane or the y-z plane. The scope of the following claims is to be accorded the broadest interpretation so as to encompass all such modifications and equivalent structures and functions.

What is claimed is:

1. A process for fabricating an electrical component having at least one anisotropic electrical quality, the process comprising the step of ink-jet printing a plurality of dots of each of at least two electronic inks in a first predetermined pattern such that the anisotropic electrical quality is manifested, wherein each dot of a given ink comprises a second predetermined pattern of one or more droplets of the given ink.

2. The process of claim 1, wherein the ink-jet printing step further comprises the steps of:
selecting a first electronic ink having a known first electrical characteristic;
selecting a second electronic ink having a known second electrical characteristic;
determining a positional layout for each of a plurality of dots for each of the first and second electronic inks such that the determined positional layout provides a response of the electrical component in accordance with the anisotropic electrical quality; and
printing each of the plurality of dots of each of the first and second electronic inks onto a substrate according to the determined positional layout.

3. The process of claim 2, the positional layout being three-dimensional, and the step of determining a positional layout further comprising providing a unique set of three coordinates to each droplet of each of the first and second electronic inks, wherein a first coordinate and a second coordinate jointly specify a unique position on the substrate and a third coordinate specifies an ink layer, wherein when two dots have matching first and second coordinates, the dot having a greater third coordinate is positioned directly above the dot having a lesser third coordinate.

4. The process of claim 1, wherein the anisotropic electrical quality is selected from the group consisting of: directional conductivity; graded resistivity; directional inductance; graded inductance; and graded permittivity.

5. The process of claim 2, wherein the known first and second electrical characteristics are selected from the group consisting of: conductivity, resistivity, permittivity, and dielectric constant.

6. The process of claim 2, wherein the step of printing comprises using an ink-jet printer having at least two ink-jet heads to print each of the plurality of dots of the first electronic ink using a first ink-jet head and to print each of the plurality of dots of the second electronic ink using a second ink-jet head.
